(19) United States
(12) Patent Application Publication
(10) Pub. No.: US 2005/0076494 A1
(43) Pub. Date: Apr. 14, 2005

(54) Quickly-coupled delivery device for automatic machines for applying buttons and other metal fittings on a support and machine including the delivery device

(76) Inventor: Gaetano Raccosta, Merate (LC) (IT)

Correspondence Address: James V. Costigan;Hedman & Costigan, P.C., 1185 Avenue of the Americas, New York, NY, 10036-2646, US

(21) Appl. No.: 11/002,863

(22) Filed: Dec. 2, 2004

(30) Foreign Application Priority Data
May 12, 2003 (IT) MI 2003A 002395

(51) Int. Cl. F16L 55/00; B65D 57/00

(52) U.S. Cl. 29/720; 29/705; 29/707; 29/709

(57) ABSTRACT

A quickly-coupled delivery device for automatic machines for applying buttons and other metal fittings on a support comprises a hopper and a rotary bell which is rotatively driven by a driving shaft, in turn driven by a belt transmission, provided with a quick coupling system for operating the rotary bell, and adapted to allow the belt transmission to be received inside the body of the machine. The inventive device, owing to its quick coupling system arranged on the bell driving shaft, so as to allow the drive belts to be brought inside the body of the machine, facilitates and simplifies the delivery device opening operations; moreover, the quick coupling of the rotary bell on the driving shaft facilitates the empting operations for removing from the bell the metal fittings.

### BACKGROUND OF THE INVENTION

The present invention relates to a quickly-coupled delivery device for automatic machines for applying buttons and other metal fittings on a support, such as a support fabric.

The invention also related to a machine including the mentioned delivery device.

The field of the invention is that of the machines used for automatically applying buttons and other metal fittings in general on supports, such as a support fabric and the like, as known, the above machines conventionally comprise a fitting delivery or distributing device arranged on supporting guides, and designed for sending the mentioned metal fittings, by loading rod elements, toward an applying region for applying said metal fittings to the support fabric. Thus, the function of the above mentioned delivery or distributing device is that of individually supplying the metal fittings to the applying machine, starting from hoppers storing said metal fittings.

The above mentioned delivery device essentially comprise a hopper, supported on a supporting plate, therein are stored the metal fittings to be applied.

On the other side of the supporting plate, is mounted a rotary bell, which can turn about a rotary shaft rigid with the supporting plate and adapted to allow individual metal fittings to fall, with an oriented position, toward an underlying guide.

The rotary bells, in particular, are driven by driving or transmission belts outside of the body of the machine, and in turn driven by driving pulleys, also arranged outside the machine body, and entrained by a driving or entraining shaft.

Depending on a desired application, the hoppers can be arranged either at an outside or inside position with respect to the machine body.

Anyhow, for fully empting the delivery device, i.e. removing the metal fittings therefrom to replace the latter by other desired metal fittings, it is necessary to open the delivery device by causing it to turn about its pivot axis to the machine frame.

Thus, it will be possible to remove all the metal fittings arranged inside the metal fitting guides.

However, the provision of the outer driving belts for driving said rotary bells would hinder the disclosed delivery device opening operation.

To the above it is to be further added that the remaining metal fittings, held inside the rotary bell, can be removed exclusively by performing a manual removing operation, since it is not possible to remove or quickly disassemble the bells from the delivery or distributor device.

### SUMMARY OF THE INVENTION

Accordingly, the main object of the present invention is to provide a novel delivery device adapted to make operation from removing it from the machine body much simpler and safe, thereby allowing to easily remove metal fittings from their guides.

Another object of the present invention is to make much more quick and simple the operations necessary for removing metal fittings remained inside the rotary bell, after having emptied the hopper and guides.

According to one aspect of the present invention, the above and yet other objects are achieved by a device and machine according to claims 1 and 12, respectively.

Preferred embodiments of the invention are defined by the remaining dependent claims.

With respect to the prior art in this field, the delivery device according to the invention, owing to the provision of a quick coupling system on the bell driving shaft, allowing to bring the driving belts inside the machine body, facilitates and simplifies the delivery device opening operations.

Moreover, the quick coupling system for coupling the rotary bell on the driving shaft will facilitate the empty operations for removing from the bell the metal fittings.

Advantageously, furthermore, the provision of metal fitting sensor means on gripper elements therefor, prevents said metal fittings from being erroneously assembled onto the support fabric.

### BRIEF DESCRIPTION OF THE DRAWINGS

The above mentioned and other objects, advantages and features of the invention will become more apparent thereinafter from the following detailed disclosure of the inventive device and machine which are illustrated, by way of a non limitative example, in the figures of the accompanying drawings, where:

FIG. 1 is a front view illustrating the machine according to the invention;

FIG. 2 illustrates details of the delivery devices, in an open position thereof, and related to the machine shown in FIG. 1;

FIG. 3 illustrates a detail of the opening operation for opening the rotary bell with respect to the delivery device shown in FIG. 2;

FIG. 4 is a longitudinal cross-sectional view illustrating the locking system, provided with a bayonet clutch, for locking the rotary bell on the delivery device shown in the preceding figures;

FIG. 5 illustrates the system of FIG. 4 with the bell being withdrawn or removed from the delivery device;

FIG. 6 is an exploded perspective view illustrating the system shown in FIG. 4.

### DESCRIPTION OF THE PREFERRED EMBODIMENTS

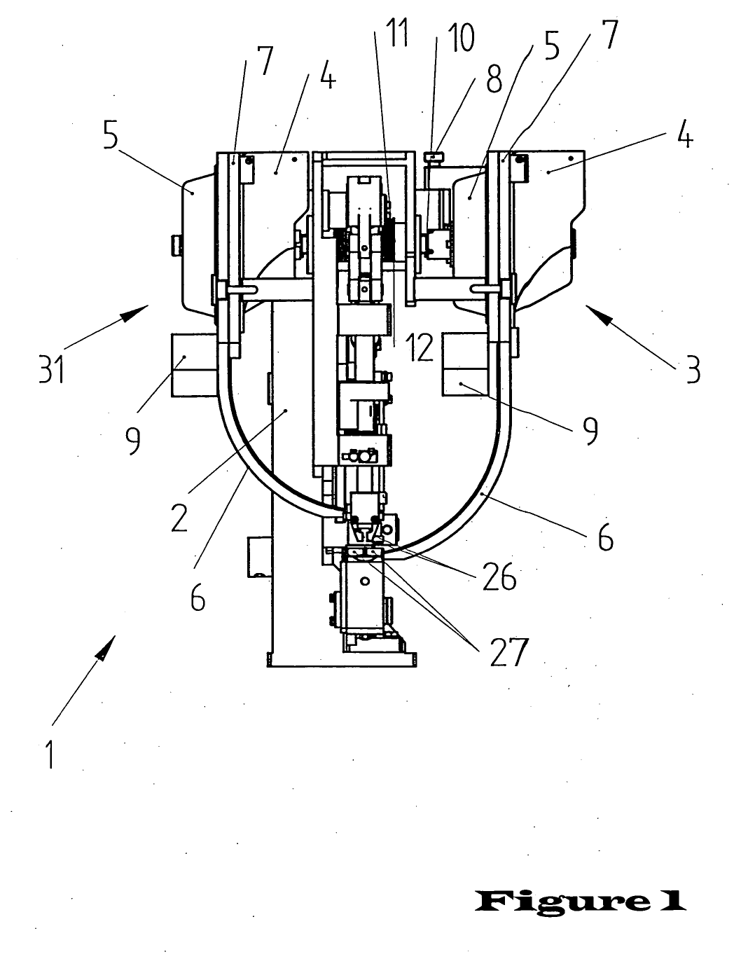

The machine according to the invention, shown in FIG. 1, has been generally indicated by the reference number 1.

Said machine comprises a machine body 2 including two delivery or distributing device 3,31 each comprising a hopper 4, a rotary bell 5 and a metal fitting guide 6, the assembly being supported by a supporting plate 7 pivoted to the machine body 2 at a pivot pin 8.

Advantageously, the delivery or distributor devices 3,31 further comprises a conveyor 9 for conveying the remaining metal fittings.

The rotary bell 5 is rotatively driven by a driving shaft 10, in turn driven by entraining or driving belts 11 entrained on pulleys 12 which are rigid with said shaft 10.

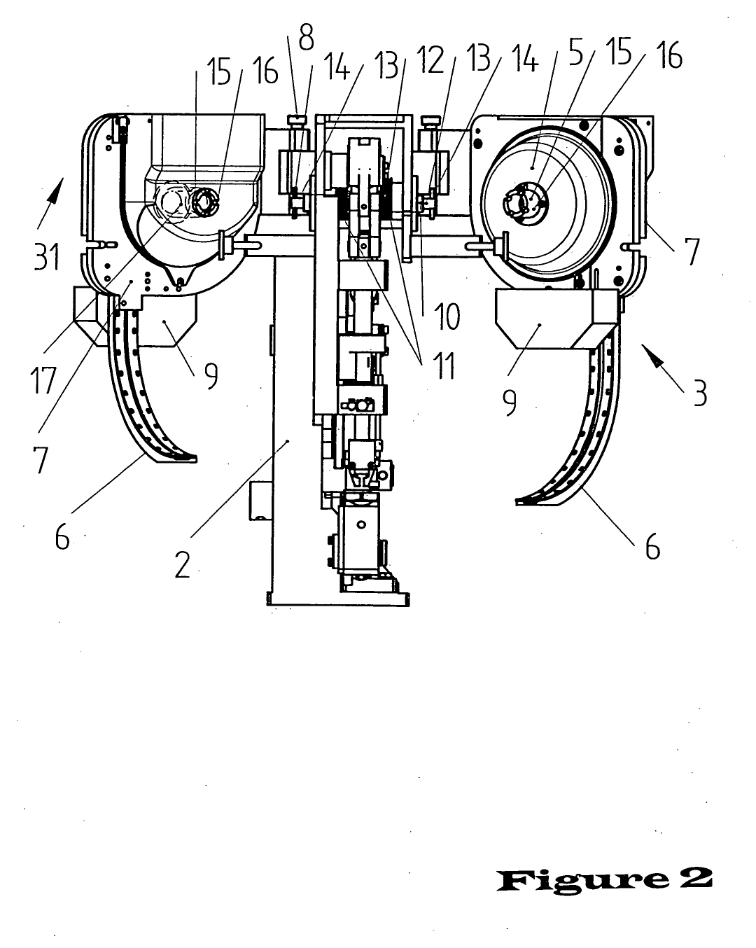

At a free end portion thereof, the shaft 10 comprises a pin 13 (FIG. 2) including radially projecting elements or pins 14.

Said end portion of the shaft 10 can be coupled inside a coupling sleeve 15, including radially extending grooves 16 adapted to receive said radially extending elements 14.

In the embodiment of the delivery device 3 including a rotary bell facing the inside of the machine body, the coupling sleeve 14 is clamped on the body of the same bell 5.

On the other hand, in the case of a delivery device 31 having a rotary bell facing the outside of the machine body, the coupling sleeve 15 is clamped to the driving shaft 17 of the same bell 5.

In the closed condition of the delivery device, the engagement of the radially extending elements 14 of the pin 13 of the shaft 10 inside the grooves 16 of the coupling sleeve 15 provides a quick coupling of the bell 5 on the system or assembly constituted by the entrainment belts 11 and driving shaft 10 (FIG. 1).

On the other hand, said quick coupling mechanism will allow the delivery device 3,31 to be easily opened with respect to the body 2 of the machine, owing to a separated engagement of the entrainment or driving belts 11 inside said body 2.

Thus, it is possible to fully remove from the guide 6 remaining fittings still present inside said guides.

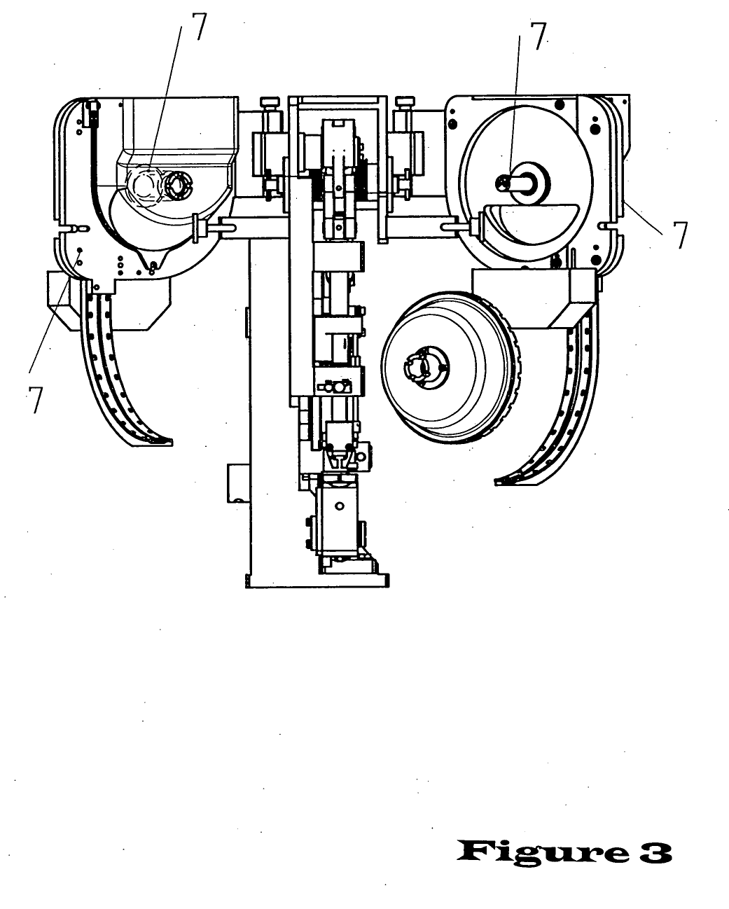

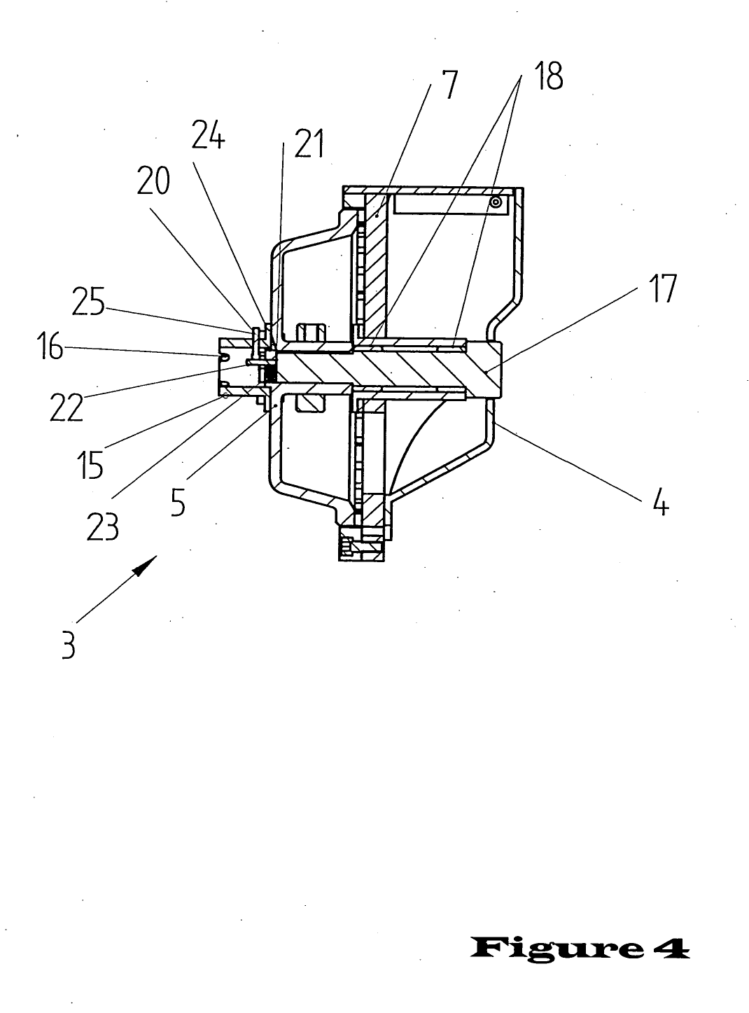

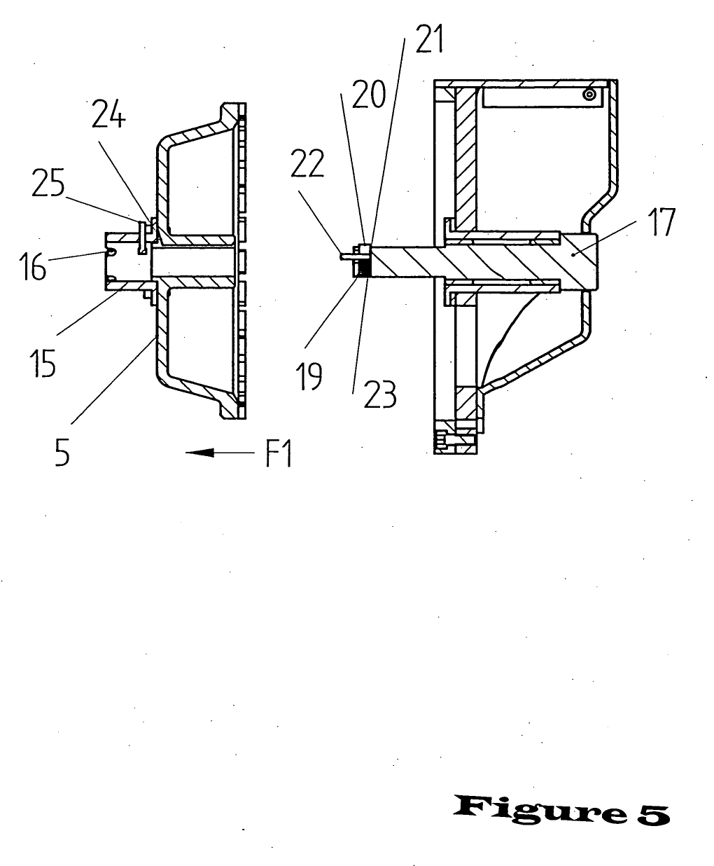

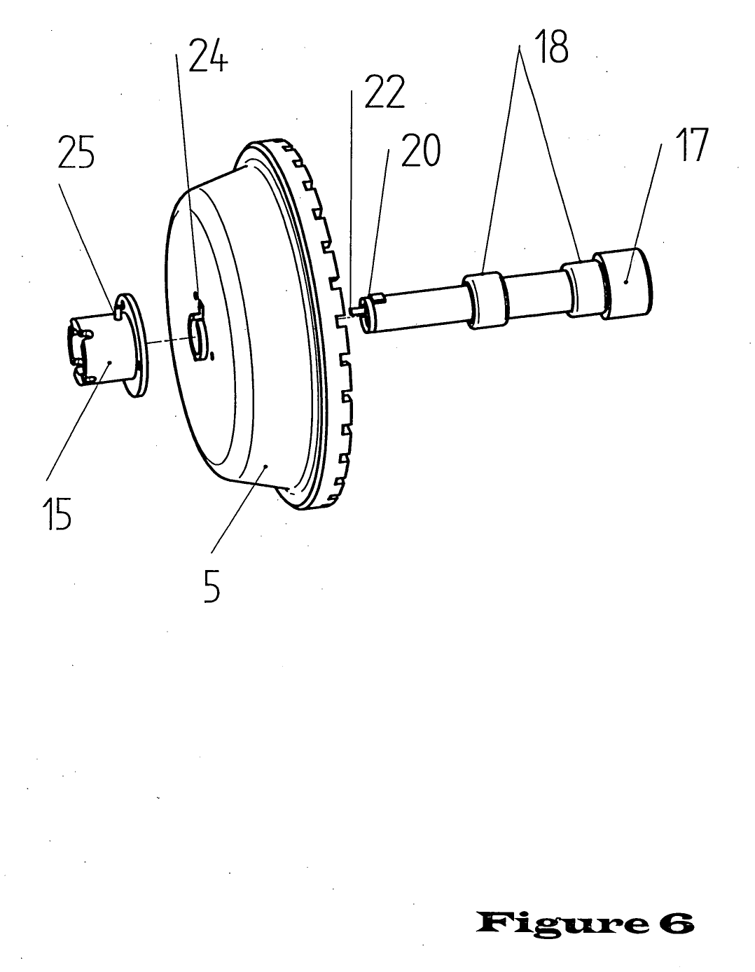

For fully empting both the hoppers 4 and bells 5, the inventive device comprises a bayonet quick coupling or locking system, as shown in FIGS. 3 to 6.

This locking system comprises, on the shaft 17 end of the bell 5, a hollow recess 19 for housing a key element 20 projecting from a hole 21 of said recess 19 at a radial position with respect to the shaft 17.

Rigid with said key 20 is provided an operating pawl, adapted to manually drive the lowing of the key 20 inside its housing recess 19, against the biassing of an urging spring 23.

Said end portion of the shaft 17 is designed for engaging-inside the bell 5, thereby arranging the key 20 in a corresponding slot 24 of said bell, thereby allowing the rotary shaft 17 to rotatively drive said bell: in the disclosed embodiment of the delivery device 3, the sleeve 15 will operatively drive the bell 5 which, in turn, will entrain the shaft 17 on the bearings 18; in the embodiment of the delivery device 31, the sleeve 15 is rigid with the shaft 17, which drives the bell 5.

A lever 25 supported by the bell 5, for lowing the key 20 thereby disengaging the bell from the shaft 17 is furthermore provided.

Thus, starting with the delivery device in its open position of FIGS. 2 and 3, it is possible to quickly remove the bell 5 from said delivery device, thereby allowing the remaining metal fittings to be fully removed from the delivery device, by causing said metal fittings to fall on the conveyors 9.

Advantageously, on a top gripper element 26 and bottom jaw elements 27 (FIG. 1) a plurality of sensors (not shown) for sensing the presence of said metal fittings are provided, said sensors being adapted to prevent the machine from operating in a case of a full or partial absence of the metal fittings at their applying region.

Instead of the above disclosed radially extending element 14 and radial groove 16 assembly, the quick coupling system of the inventive delivery device could also comprise other means, of any suitable nature and adapted to be mutually coupled, thereby driving the rotary bell, and being adapted to be removed for opening the delivery device.

1. A quickly-coupled delivery device for automatic machines for automatically applying buttons and other metal fittings in general on a support element, of a type comprising a hopper and a rotary bell rotatively driven by a driving shaft, in turn driven by a belt transmission, characterized in that said device further comprises means for housing said belt transmission inside a body of said machine.

2. A device according to claim 1, characterized in that said housing means for housing said belt transmission inside the body of said machine comprise a quick coupling device for driving said rotary bell.

3. A device according to claim 2, characterized in that said quick coupling device comprises coupling means adapted to be mutually coupled, thereby driving said rotary bell, and being further adapted to be separated from opening said delivery device.

4. A device according to claim 3, characterized in that said coupling means comprise coupling pins and grooves, respectively arranged at an end portion of said driving shaft facing said rotary bell and on a coupling sleeve fixed to the body of said bell or to a further driving shaft.

5. A device according to claim 4, characterized in that said pins radially project from a pivot element clamped to said end portion of said driving shaft.

6. A device according to claim 1, characterized in that said device further comprises a supporting plate pivotably coupled to said machine body.

7. A device according to claim 1, characterized in that said device further comprises means for quickly opening said bells.

8. A device according to claim 7, characterized in that said means comprise a locking system for locking said bell by a bayonet type of coupling.

9. A device according to claim 8, characterized in that said locking system comprises, on an end portion of said further shaft of said bell, a hollow recess for housing a key element therein, said key element being adapted to engage inside a corresponding slot of said bell.

10. A device according to claim 9, characterized in that said device further comprises an operating pawl and lever driving assembly, for manually driving said key element to lower inside said recess therefor, against a biassing of an urging spring.

11. A device according to claim 1, characterized in that said device further comprises a conveyor for conveying remaining metal fittings.

12. A machine for automatically applying buttons and other metal fittings in general on a support, characterized in that said machine comprises a device according to claim 1.

13. A machine according to claim 12, characterized in that said belts of said belts transmission are housed inside said machine body.

14. A device according to claim 13, characterized in that said machine comprises a top gripper element and lower jaw elements including a plurality of sensor for sensing a presence of said metal fittings, said sensors being adapted to prevent said machine from operating as a full or partial absence of said metal fittings is sensed at an applying region thereof.

15. A device according to claim 12, characterized in that said support comprises a support fabric.
